(19) United States
(12) Patent Application Publication
(10) Pub. No.: US 2010/0282096 A1
(43) Pub. Date: Nov. 11, 2010

(54) COOKING UTENSIL

(76) Inventor: Caleb Jay Fletcher, Centerville, MI (US)

Correspondence Address: ROBERT J. SAYFIE, P.C., 161 OTTAWA AVENUE NW, SUITE 407, GRAND RAPIDS, MI, 49503, US

(21) Appl. No.: 12/437,623

(22) Filed: May 8, 2009

(51) Int. Cl. A47J 33/00; F16H 21/48

(52) U.S. Cl. 99/421 A; 99/421 H; 99/441; 74/63

(57) ABSTRACT

A utensil, having a handle (20); a tube (40); a shaft (50) having a proximal end (60) and having a distal end (70). The shaft (50) rotatably disposed within the tube (40); a shaft gear (80) disposed on the distal end (70); a rod gear (90) engaged with the shaft gear (80), the rod gear (90) fixed to a rod (100) whereby when the shaft (50) and the rod (100) rotate in unison; the rod (100) rotatably disposed in a housing (120); a frame (110) attached to the tube (40) and the housing (120); and a skewer portion (130) disposed on the rod (100).

### GOVERNMENT RIGHTS

This invention was not made with Government support under. The Government does not have any rights in this invention.

### BACKGROUND OF THE INVENTION

The present invention is an apparatus that may be used to cook hot dogs over campfires.

The relevant art includes the below patent documents. U.S. Pat. No. 3,745,910 discloses a roasting spit having tines 11 that orbit around a center of the sleeve 6. This does not rotate the food item about its own center of axis.

U.S. Pat. No. 4,517,885 discloses a wiener roaster that rotates the food about the center of a shank 12, 14. This does not rotate the food item about its own center of axis.

U.S. Pat. No. 5,117,558 discloses a barbecue rotisserie that has multiple prongs, whereby the user rotates the handle to rotate the food about the center of the shaft 12. This does not rotate the food item about the food's own center of axis.

U.S. Pat. No. 5,355,778 discloses a rotatable food roasting apparatus. Here the food is within the apparatus, although the food item does rotate about its own axis. This is rotated by hand, and it does not allow two food items to be rotated about their own axis.

U.S. Pat. No. 6,196,1221 discloses a two-pronged cooking utensil.

As can be seen, there is a need for a cooking utensil that can be used to cook food over campfires, that rotates the food about an axis of rotation within the food item. There also exists a need to cook four food items at one time. There also exists a need for a campfire-cooking utensil that has a curved handle or shaft to provide for easier holding or placement of the utensil, similar to the curved handle snow shovels.

### SUMMARY OF THE INVENTION

One aspect of the present invention is a utensil, comprising: a handle (20); a tube (40); a shaft (50) having a proximal end (60) and having a distal end (70), said shaft (50) rotatably disposed within said tube (40); a shaft gear (80) disposed on said distal end (70); a rod gear (90) engaged with said shaft gear (80), said rod gear (90) fixed to a rod (1 00) whereby when said shaft (50) and said rod (100) rotate in unison; said rod (100) rotatably disposed in a housing (120); a frame (110) attached to said tube (40) and said housing (120); and a skewer portion (130) disposed on said rod (100).

Another aspect is a utensil, comprising: a handle (20); a curved tube (200); a curved shaft (190) having a proximal end (60) and having a distal end (70), said curved shaft (1900) rotatably disposed within said curved tube (200); a shaft gear (80) disposed on said distal end (70); a rod gear (90) engaged with said shaft gear (80), said rod gear (90) fixed to a rod (100) whereby when said shaft (50) and said rod (100) rotate in unison; said rod (100) rotatably disposed in a housing (120); a frame (110) attached to said tube (40) and said housing (120); and a skewer portion (130) disposed on said rod (100).

Another aspect is a crank extension (160) fixedly connected to a crank gear (170) that is angularly displaced in one plane, said crank gear (170) is engagingly connected to a drive gear (140) so that the crank gear (170) and drive gear (140) move in unison, said drive gear (140) is disposed on a proximal end (60) of a shaft (50), said shaft (50) extending to a distal end (70) that is fixed to a shaft gear (80), said shaft gear (80) engaging with a rod gear (90), said rod gear (90) fixedly disposed on a rod (100), said rod (100) rotatably disposed in a housing (120) that is secured to the tube (40) by a frame (110), said rod (100) terminating at each end in a skewer portion (130), whereby when said crank extension (160) is rotated, said skewer portion (130) rotates, and each skewer portion (130) may cause a food item disposed thereon to rotate about one axis of rotation.

These and other features, aspects and advantages of the present invention will become better understood with reference to the following drawings, description and claims.

### BRIEF DESCRIPTION OF THE DRAWINGS

FIG. 1 is a pictorial of an embodiment of a side view of the present invention;

FIG. 2 is a pictorial of an embodiment of a top view of the present invention;

FIG. 3 is a pictorial of an embodiment of a side view of the shaft 50, shaft gear 80, and rod gear 90 of the present invention;

FIG. 4 is a pictorial of an embodiment of a top view of the shaft 50, shaft gear 80, and rod gear 90 of the present invention;

FIG. 5 is a pictorial of an embodiment of a side view of the present invention;

FIG. 6 is a pictorial of an embodiment of a top view of the present invention;

FIG. 7 is a pictorial of an embodiment of a present invention showing the crank assembly 30;

FIG. 8 is a pictorial of an embodiment of a present invention with four skewer portions;

FIG. 9 is a pictorial of an embodiment of a top view of a crank assembly 30;

FIG. 10 is a pictorial of an embodiment of a side view of a crank assembly 30;

FIG. 11 is a pictorial of an embodiment of a present invention with a curved shaft 190 and curved tube 200.

### DETAILED DESCRIPTION OF THE INVENTION

### Reference Numerals

10 utensil

20 handle

30 crank assembly

40 tube

50 shaft

60 proximal end

70 distal end

80 shaft gear

90 rod gear

100 rod

110 frame

120 housing

130 skewer portion

140 shaft drive gear

150 crank

160 crank extension

170 crank gear

180 plate

190 curved shaft

200 curved tube

The following detailed description is of the best currently contemplated modes of carrying out the invention. The description is not to be taken in a limiting sense, but is made merely for illustrating the general principles of the invention, since the scope of the invention is best defined by the appended claims.

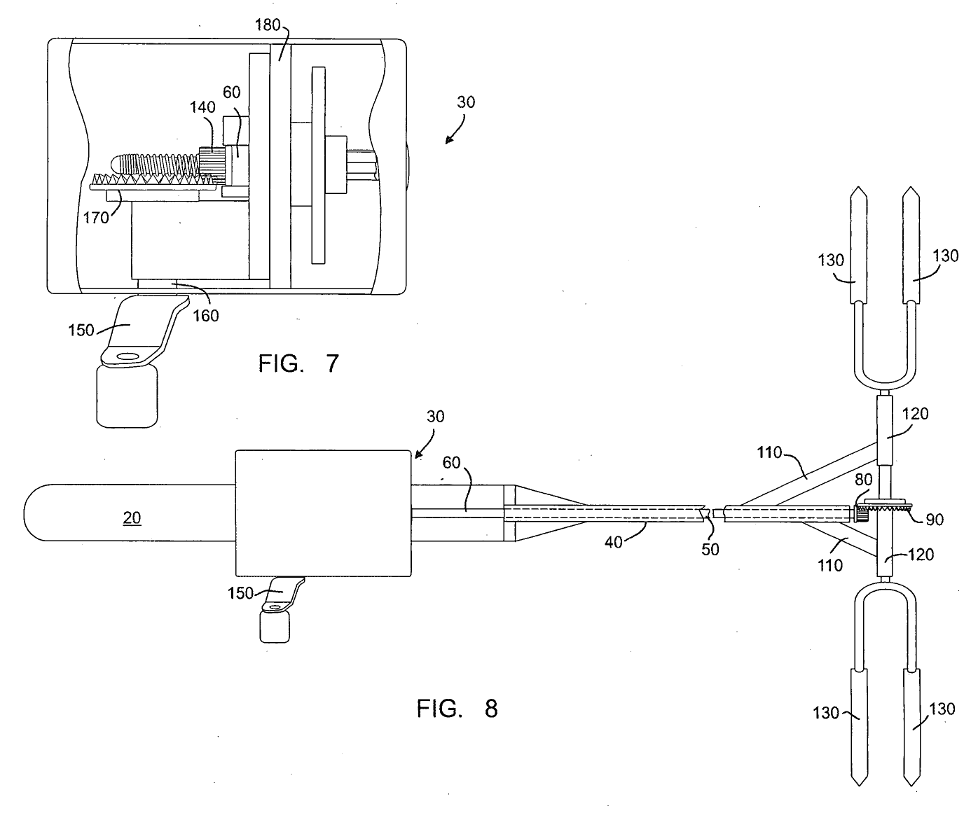

FIG. 1 illustrates an embodiment of the present invention showing a handle 20 with a crank assembly 30 that may be secured to the handle 20. The crank assembly 30 may have a crank 150 that may be connected to a crank gear 170, as illustrated in FIG. 7. The crank 150 may be connected to a crank gear 170 via a crank extension 160. The crank gear 170 may be engaged with a shaft drive gear 140 that may be disposed on a proximal end 60 of a shaft 50.

A shaft 50 may extend from the crank assembly 30. The shaft 50 may have the proximal end 60 and may have a distal end 70. The shaft 50 may be rotatably disposed within a tube 40. A shaft gear 80 may be disposed at the distal end 70. A frame 110 may be disposed at the distal end 70 and may connect to a housing 120. The housing 120 may be tube shaped and hollow to rotatably receive a rod 100. The rod 100 may have a rod gear 90 that may engage with the shaft gear 80, whereby said shaft gear 80 and said rod gear 90 rotate in unison. The rod 100 may have a skewer portion 130 at each end.

FIG. 1 also illustrates a crank assembly 30 having a crank 150 that may be manually displaced or rotated so as to displace the crank gear 170 that therefore may engage and displace the drive gear 140 and shaft gear 80, which displaces the rod gear 90 to rotate food that may be disposed on the skewer portions 130.

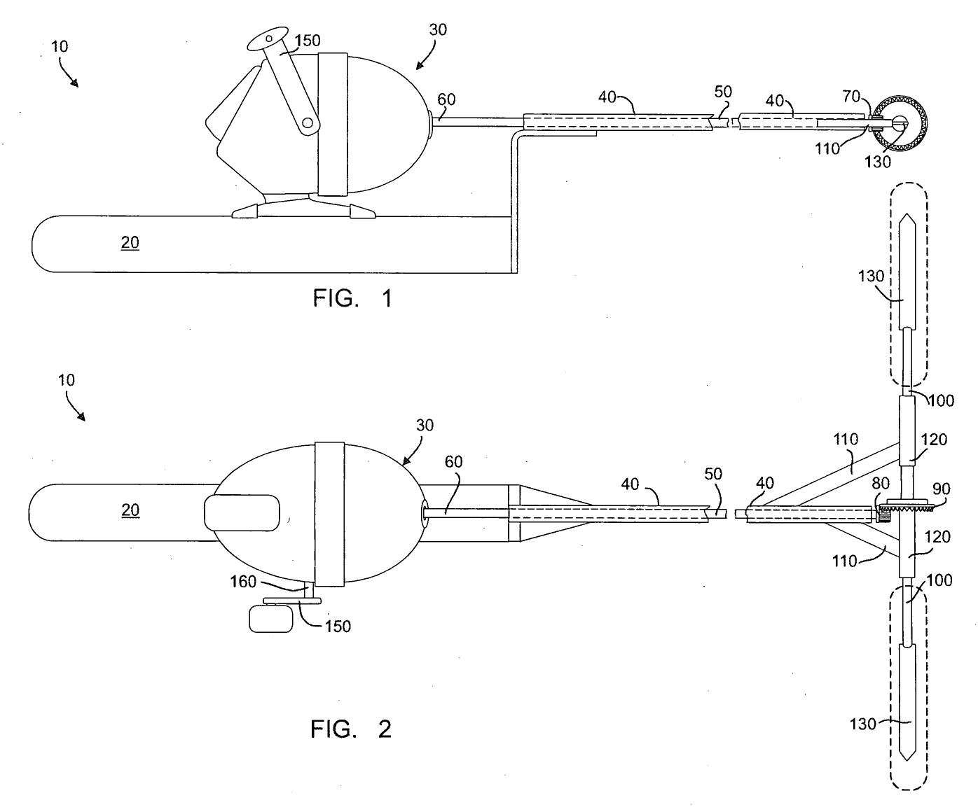

FIG. 2 illustrates a top view and the skewer portions 130 in which food items, such as hot dogs, may be disposed. FIG. 2 illustrates one embodiment where the rod 100 is disposed essentially perpendicular to the shaft 50.

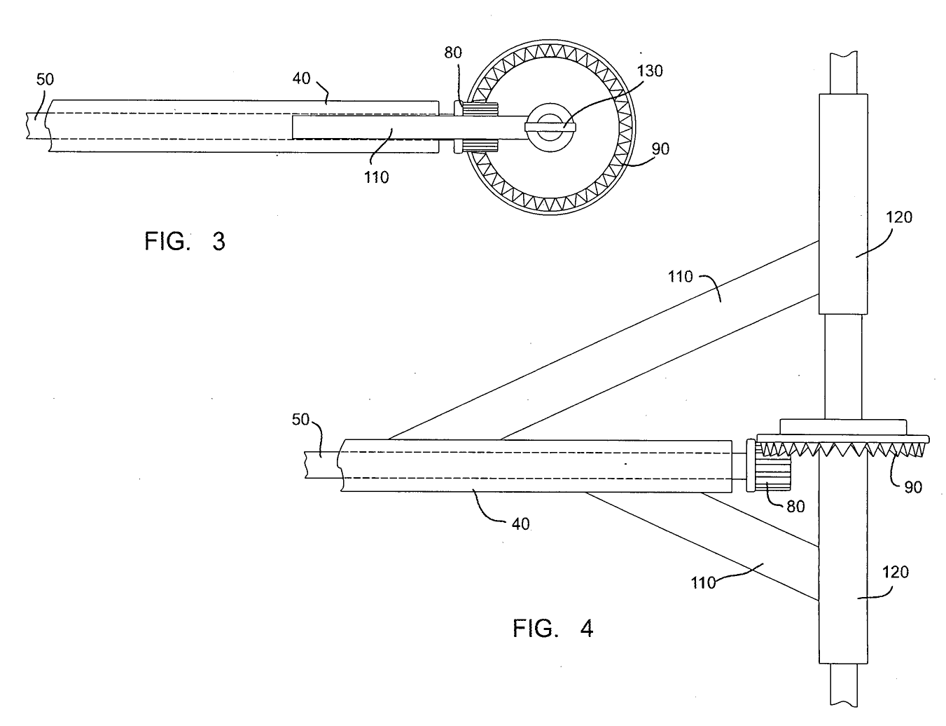

FIGS. 3 and 4 illustrate a closer view of the shaft 50 that is rotatably disposed within the tube 40, than FIGS. 1 and 2. The frame 110 is fixed to a housing 1 20 that receives a rod 100.

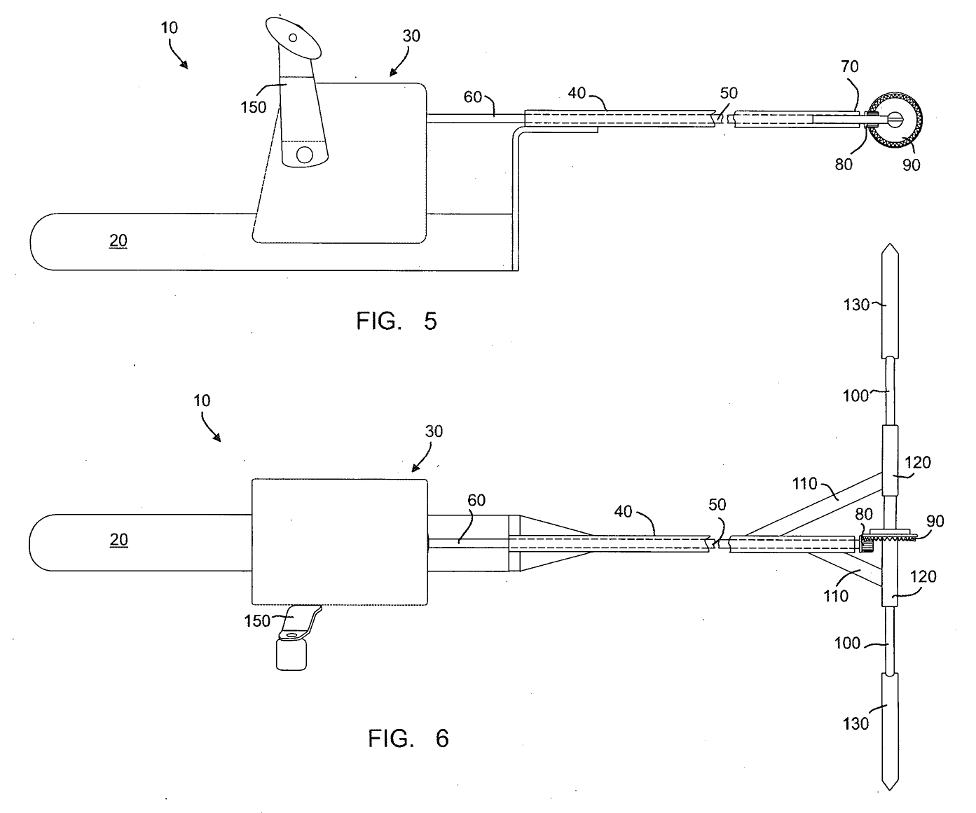

FIGS. 5 and 6 illustrate an embodiment of the present invention food utensil 10. These FIGS. 5 and 6 are similar to FIGS. 1 and 2 except the crank assembly 30 is more square shaped and less rounded than the crank assemble 30 as illustrated in FIGS. 1 and 2.

FIG. 7 illustrates an inside of the crank assembly 30. The crank 150 may have a crank extension 160 that extends from the crank 150 to the crank gear 170, which may engage with the drive gear 140 that is disposed on the proximal end 60 of the shaft 50. The proximal end 60 may be rotatably disposed in a plate 180 that is secured to the inside of the crank assembly 30.

FIG. 8 illustrates an embodiment of the present invention food utensil 10 having four skewer portion 130, two skewer portions 130 on one side of the rod 100, and two skewer portions 130 on the other end of the rod 100.

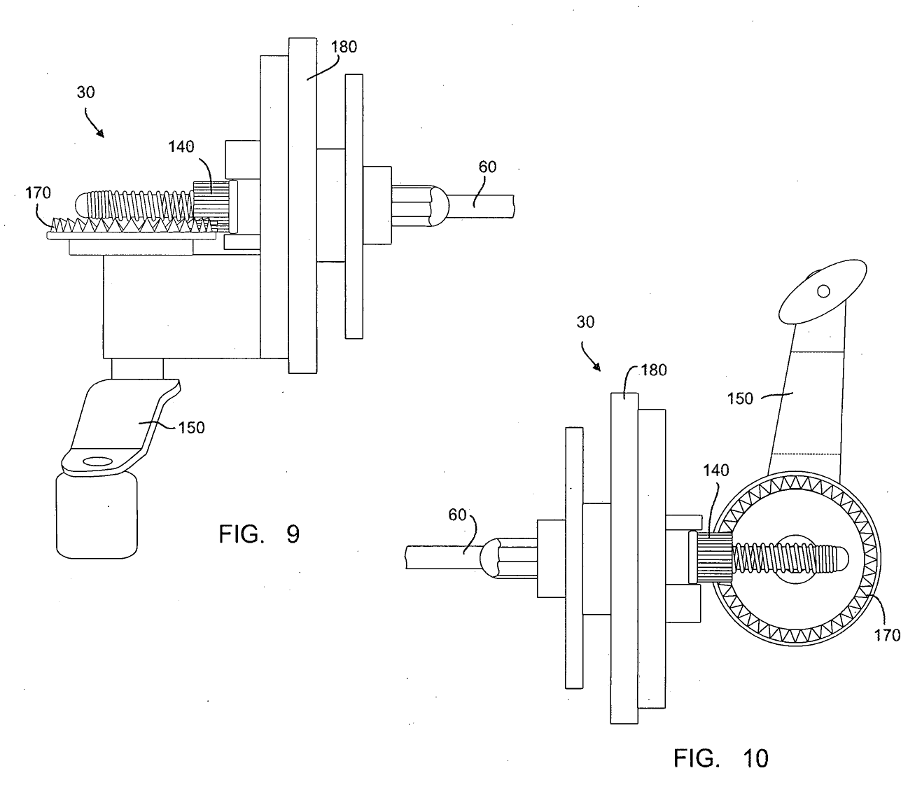

FIGS. 9 and 10 illustrate one embodiment of the crank assembly 30. The proximal end 60 of the shaft 50 is shown extending from the crank assembly 30.

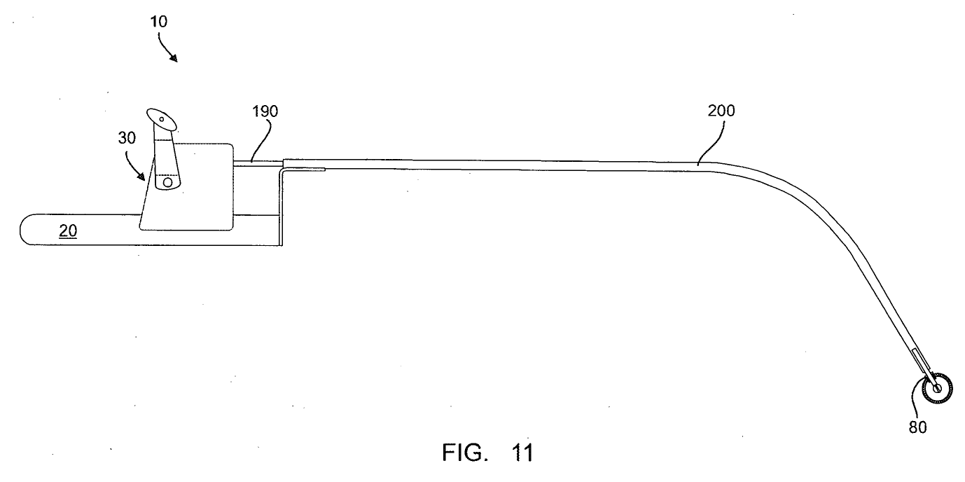

FIG. 11 illustrates an embodiment of the present invention 10 having a curved shaft 1 90 that is rotatably disposed within a curved tube 200. Here, the curved shaft 190 may be made of a flexible cable that can rotate within the curved tube 200. Like FIG. 1, this embodiment may have a distal end 70 having a shaft gear 80 thereon.

It should be understood, of course, that the foregoing relates to exemplary embodiments of the invention and that modifications may be made without departing from the spirit and scope of the invention as set forth in the following claims.

I claim:

1. A utensil, comprising:
a handle (20);
a tube (40);
a shaft (50) having a proximal end (60) and having a distal end (70), said shaft (50) rotatably disposed within said tube (40);
a shaft gear (80) disposed on said distal end (70);
a rod gear (90) engaged with said shaft gear (80), said rod gear (90) fixed to a rod (100) whereby when said shaft (50) and said rod (100) rotate in unison; said rod (100) rotatably disposed in a housing (120);
a frame (110) attached to said tube (40) and said housing (120); and
a skewer portion (130) disposed on said rod (100).

2. The apparatus of claim 1, further comprising:
a crank assembly (30) disposed on said handle (20);
said crank assembly (30) rotatably receives said proximal end (60);
said proximal end (60) having a rod drive gear (140) disposed thereon;
a crank extension (160) rotatably connected to said crank assembly (30), said crank extension (160) having a crank gear (170) disposed thereon, said crank gear (170) engages with said rod drive gear (140), whereby said crank gear (170) rotates and is engaged with said rod drive gear (140), which rotates said shaft gear (80), which rotates and is engaged with said rod gear (90), which rotates said rod (100) to rotate said skewer portions (130).

3. A utensil, comprising:
a handle (20);
a curved tube (200);
a curved shaft (190) having a proximal end (60) and having a distal end (70), said curved shaft (1900) rotatably disposed within said curved tube (200);
a shaft gear (80) disposed on said distal end (70);
a rod gear (90) engaged with said shaft gear (80), said rod gear (90) fixed to a rod (100) whereby when said shaft (50) and said rod (100) rotate in unison; said rod (100) rotatably disposed in a housing (120);
a frame (110) attached to said tube (40) and said housing (120); and
a skewer portion (130) disposed on said rod (100).

4. The apparatus of claim 3, further comprising:
a crank assembly (30) disposed on said handle (20);
said crank assembly (30) rotatably receives said proximal end (60); said proximal end (60) having a rod drive gear (140) disposed thereon;
a crank extension (160) rotatably connected to said crank assembly (30), said crank extension (160) having a crank gear (170) disposed thereon, said crank gear (170) engages with said rod drive gear (140), whereby said crank gear (170) rotates and is engaged with said rod drive gear (140), which rotates said shaft gear (80), which rotates and is engaged with said rod gear (90), which rotates said rod (100) to rotate said skewer portions (130).

5. A crank extension (160) fixedly connected to a crank gear (170) that is angularly displaced in one plane, said crank gear (170) is engagingly connected to a drive gear (140) so that the crank gear (170) and drive gear (140) move in unison, said drive gear (140) is disposed on a proximal end (60) of a shaft (50), said shaft (50) extending to a distal end (70) that is fixed to a shaft gear (80), said shaft gear (80) engaging with a rod gear (90), said rod gear (90) fixedly disposed on a rod (100), said rod (100) rotatably disposed in a housing (120) that is secured to the tube (40) by a frame (110), said rod (100) terminating at each end in a skewer portion (130), whereby when said crank extension (160) is rotated, said skewer portion (130) rotates, and each skewer portion (130) may cause a food item disposed thereon to rotate about one axis of rotation.

6. The apparatus of claim 5, further comprising:
a crank assembly (30) disposed on said handle (20);
said crank assembly (30) rotatably receives said proximal end (60); said proximal end (60) having a rod drive gear (140) disposed thereon;
a crank extension (160) rotatably connected to said crank assembly (30), said crank extension (160) having a crank gear (170) disposed thereon, said crank gear (170) engages with said rod drive gear (140), whereby said crank gear (170) rotates and is engaged with said rod drive gear (140), which rotates said shaft gear (80), which rotates and is engaged with said rod gear (90), which rotates said rod (100) to rotate said skewer portions (130).

7. The apparatus of claim 5, wherein said tube (40) and said shaft (50) is a curved, and said shaft (50) is made of a flexible material.

8. The apparatus of claim 5, wherein said tube (40) and said shaft (50) is made of a rigid material.
